(19) United States
(12) Patent Application Publication
(10) Pub. No.: US 2022/0042214 A1
(43) Pub. Date: Feb. 10, 2022

(54) CORD FABRIC FOR TIRE REINFORCEMENT

(71) Applicant: KORDSA TEKNIK TEKSTIL A.S., Kocaeli (TR)

(72) Inventors: Yucel AYYILDIZ, Kocaeli (TR); Sadettin FIDAN, Kocaeli (TR); Caner IHTIYAR, Kocaeli (TR); Bekir Anil MERTOL, Kocaeli (TR)

(73) Assignee: KORDSA TEKNIK TEKSTIL A.S., Kocaeli (TR)

(21) Appl. No.: 17/291,001

(22) PCT Filed: Dec. 18, 2018
(86) PCT No.: PCT/TR2018/050825

§ 371 Date: May 4, 2021

(30) Foreign Application Priority Data
Nov. 6, 2018 (TR) 2018/16640

(51) Int. Cl. D02G 3/48; B29D 30/40; B60C 9/00; B60C 9/11

(52) U.S. Cl. CPC D02G 3/48; B29D 30/40; B29D 2030/383; B60C 9/11; D10B 2505/022; B60C 9/0042

(57) ABSTRACT

A tire reinforcement fabric is woven with predipped and heat-set single cords as warp bound together with weft materials, and a pneumatic tire includes a tire reinforcement fabric. The tire reinforcement fabric is obtained by weaving individually dipped cords as warp material and a plurality of any kind of weft materials.

### CROSS REFERENCE TO THE RELATED APPLICATIONS

This application is the national phase entry of International Application No. PCT/TR2018/050825, filed on Dec. 18, 2018, which is based upon and claims priority to Turkish Patent Application No. 2018/16640, filed on Nov. 6, 2018, the entire contents of which are incorporated herein by reference.

### TECHNICAL FIELD

The present invention relates to a tire reinforcement fabric which is obtained by weaving an individually dipped cord material with a weft material and production method thereof. The present invention also related with pneumatic tires comprising at least one reinforcement fabric which is obtained by an individually dipped cord material with a weft material.

### BACKGROUND

In cord fabrics employed to reinforce the pneumatic tires, it is important that the cords have the sufficient tensile properties and good adhesion between the cords and the rubber which is needed for resistance under repeated stresses in service. Poor adhesion with the rubber results in what is termed as ply separation and deterioration of the cords due to cyclic bending is termed as fatigue.

It is well known practice to dip and heat-set the greige cord fabrics after weaving process to provide the sufficient adhesion and the needed physical properties.

The ply stiffness (resistance to elongation and creep) in tire carcass and cap ply is controlled by LASE value, linear density, and epdm (ends per decimeter, end count in fabric) of the cord fabric. The high epdm cord fabrics show some adhesive dip webbing (adhesive dip film formation between the cords) problem which prevents the rubber penetration between the individual cords during calendaring and curing process. Under high-speed conditions, such limited rubber penetration could reduce the tire durability by early ply separations.

On the other hand, the conventional cord fabrics which are dipped and heat-set after weaving process, have some contact points with wefts at cross-over points. The adhesive dip content at those contact points are very low, and could initiate early crack initiations under dynamic conditions.

Primary object of the present invention is to eliminate the above-mentioned shortcomings in the prior art.

A further object of the present invention is to increase the adhesion between rubber and cord fabric to prevent ply separation during calendaring and curing process, provide high ply stiffness and prevent blank points of the weft threads.

A further object of the present invention is to provide a method for obtention of such reinforcement material.

### DETAILED DESCRIPTION OF THE EMBODIMENTS

The invention is related with a reinforcement fabric which is comprising of individually dipped and heat-set single cords as warp material which are woven together with any kind of weft material and a method for obtention thereof. That means, the single warp cords preferably in forms of twisted yarn(s), are dipped and heat-set first, and then a plurality of the said dipped and heat-set cords are woven together with weft materials as reinforcement fabric for pneumatic tires. The twist level of the said cords are between 150-700 tpm. If the twist level is less than 150 tpm, compression fatigue performance decreases. If it is higher than 700 tpm, breaking strength and modulus increases.

The present invention is also related with a pnenumatic tire comprising a tire component having a tire reinforcement fabric prepared by weaving individually dipped cords as warp.

Such tire reinforcement fabrics have three major advantages such as the cord fabrics of the present invention have no adhesive dip webbing problem between the adjacent cords, and therefore rubber can easily penetrate between the adjacent cords during calendaring and curing process which enhances ply separation resistance under dynamic conditions. Secondly, the invented tire reinforcement fabric provides to have a very high cord density (epdm) which is possible without observing any adhesive dip webbing problem. When the cord density increases cord to cord distance decreases (low rivet area), but at the same time it means higher number of cords per decimeter and provides high ply stiffness, which is needed to resist the tire growth. Another advantage of the present invention is that the surface of every single cord in the fabric according to the invention is uniformly covered with adhesive dip without any blank points or the cross-over points with weft threads.

According to the invention, in order to have increased tensile strength and stiffness, the cord-to-cord distance between cords (rivet area) is adjusted as less than 0.3 mm and higher than 0.1 mm. The said individually dipped warp cords in reinforcement fabric are selected from at least one of the following material group or a combination thereof: nylon 6.6, nylon 6, polyester (PET), polyketone (POK), and aramid/nylon hybrid cords.

The said weft material of the present invention is selected from a list comprising of dipped or undipped cotton, polyamide, polyethylene, aramide, polyketone type materials or a combination thereof.

The total linear density of the said cord according to the invention is higher than 300 dtex and less than 10,000 dtex. If the total linear density of the said cord is less than 300 dtex, required stiffness value could not be achieved. If the total linear density is more than 10000 dtex, cord thickness increases and extra amount of rubber is required to adhere on the cord during rubber reinforcement applications accordingly and depending on that extra amount of rubber, rolling resistance increases negatively.

The said reinforcement fabric according to the invention, can be used in strip form as cap ply which is spirally wound on the belt package with 0 to 5° to the equatorial plane of the pneumatic radial tires.

In accordance with the present invention, the said cords are dipped into an aqueous dip solution preferably comprising suitable reactives known to skilled person in the art for obtention of a dipping layer comprising one or more material selected from a list consisting of polyurethane-, epoxy-, polyacrylate-, polyisocynate-, silane-, polyamide-, natural rubber latex or styrene-butadiene rubber latex, resorcinol- and formaldehyde-based materials.

In an embodiment of the present invention is obtained by using a nylon 6.6 as a warp cord which has 1400/2 dtex total linear density value, 350/350 tpm twist level, 120 epdm, cord gauge or diameter=0.65 ram and individually dipped and heat-set. A tire cord fabric is obtained by weaving of the said individually cord with a weft material and cord to cord distance (rivet area) is adjusted as 0.18 mm based on the following calculation:

Cord to cord distance between the adjacent cords in fabric=(100−epdm X cord diameter)/epdm

Epdm: ends per decimeter, number of cords per decimeter.

TPM: twist, turns per meter

The present invention further proposes a method for obtention of a tire reinforcement fabric which is comprising of an individually dipped cord and a weft material. The method for such an invention comprising the following steps:
pretreating each of the single cords by dipping the each of the single cords in a dipping solution and obtaining individually dipped cords,
drying the individually dipped cords,
and weaving the individually dipped cords as warp material with a plurality of weft yarns.

The method of the present invention characterized in that the said individually dipped warp cords have a distance between each other in between 0.10-0.30 mm.

The method of the present invention characterized in that the said individually dipped warp cords have a total linear density between 300 dtex-10,000 dtex.

The method of the present invention characterized in that the said individually dipped warp cords have a twist level of at least 150 tpm and maximum 700 tpm.

The method of the present invention characterized in that that the said individually dipped warp cords are selected from at least one of the following materials: polyamide, polyethylene, aramid, polyketone (POK) or aramide/nylon hybrid cords.

The method of the present invention characterized in that the said weft yarns are selected from a list comprising of dipped or unclipped cotton, polyamide, polyethylene, aramide, polyketone type materials or a combination thereof.

What is claimed is:

1. A tire reinforcement fabric, wherein the tire reinforcement fabric is prepared by weaving individually dipped cords as individually dipped warp cords, wherein a distance between the individually dipped warp cords is less than 0.3 mm and higher than 0.1 mm.

2. The tire reinforcement fabric according to claim 1, wherein the individually dipped warp cords have a twist level of 150 tpm to 700 tpm.

3. The tire reinforcement fabric according to claim 1, wherein the individually dipped warp cords have a total linear density of 300 dtex to 10,000 dtex.

4. The tire reinforcement fabric according to claim 1, wherein the individually dipped warp cords are at least one selected from the group consisting of polyamide, polyethylene, aramid, polyketone (POK) or aramide/nylon hybrid cords.

5. The tire reinforcement fabric according to claim 1, wherein weft yarns are selected from the group consisting of dipped or undipped cotton, polyamide, polyethylene, aramide, polyketone type materials or a combination thereof.

6. A method for obtaining a tire reinforcement fabric having individually dipped cords, comprising the following steps:
pretreating each single cord of single cords by dipping the each single cord in a dipping solution and obtaining individually dipped cords,
drying the individually dipped cords, and
weaving the individually dipped cords as individually dipped warp cords with a plurality of weft yarns.

7. The method according to claim 6, wherein the individually dipped warp cords have a distance of 0.10 mm to 0.30 mm between each other.

8. The method according to claim 6, wherein the individually dipped warp cords have a total linear density of 300 dtex to 10,000 dtex.

9. The method according to claim 6, wherein the individually dipped warp cords have a twist level of 150 tpm to 700 tpm.

10. The method according to claim 6, wherein that the individually dipped warp cords are at least one selected from the group consisting of polyamide, polyethylene, aramid, polyketone (POK) or aramide/nylon hybrid cords.

11. The method according to claim 6, wherein the weft yarns are selected from the group consisting of dipped or undipped cotton, polyamide, polyethylene, aramide, polyketone type materials or a combination thereof.

12. The tire reinforcement fabric according to claim 2, wherein the individually dipped warp cords are at least one selected from the group consisting of polyamide, polyethylene, aramid, polyketone (POK) or aramide/nylon hybrid cords.

13. The tire reinforcement fabric according to claim 3, wherein the individually dipped warp cords are at least one selected from the group consisting of polyamide, polyethylene, aramid, polyketone (POK) or aramide/nylon hybrid cords.

14. The tire reinforcement fabric according to claim 2, wherein weft yarns are selected from the group consisting of dipped or undipped cotton, polyamide, polyethylene, aramide, polyketone type materials or a combination thereof.

15. The tire reinforcement fabric according to claim 3, wherein weft yarns are selected from the group consisting of dipped or undipped cotton, polyamide, polyethylene, aramide, polyketone type materials or a combination thereof.

16. The tire reinforcement fabric according to claim 4, wherein weft yarns are selected from the group consisting of dipped or undipped cotton, polyamide, polyethylene, aramide, polyketone type materials or a combination thereof.

17. The method according to claim 7, wherein that the individually dipped warp cords are at least one selected from the group consisting of polyamide, polyethylene, aramid, polyketone (POK) or aramide/nylon hybrid cords.

18. The method according to claim 8, wherein that the individually dipped warp cords are at least one selected from the group consisting of polyamide, polyethylene, aramid, polyketone (POK) or aramide/nylon hybrid cords.

19. The method according to claim 9, wherein that the individually dipped warp cords are at least one selected from the group consisting of polyamide, polyethylene, aramid, polyketone (POK) or aramide/nylon hybrid cords.

20. The method according to claim 7, wherein the weft yarns are selected from the group consisting of dipped or undipped cotton, polyamide, polyethylene, aramide, polyketone type materials or a combination thereof.
